(19) United States
(12) Patent Application Publication
(10) Pub. No.: US 2019/0174798 A1
(43) Pub. Date: Jun. 13, 2019

(54) METHOD OF ADDING AROMA TO CONSUMABLE LIQUID

(71) Applicant: Jonatan Funtowicz, Chandler, AZ (US)

(72) Inventor: Jonatan Funtowicz, Chandler, AZ (US)

(21) Appl. No.: 16/217,271

(22) Filed: Dec. 12, 2018

Related U.S. Application Data
(60) Provisional application No. 62/597,490, filed on Dec. 12, 2017.

(51) Int. Cl. A23L 2/52; C12G 1/00

(52) U.S. Cl. CPC A23L 2/52; A23L 27/12; C12G 2200/21; C12G 1/00

(57) ABSTRACT

The present application relates generally to compositions and methods for adding an aroma to foods and consumable liquids. The methods utilize spraying essential oil compositions that can provide an aroma, without altering the taste of the food or liquid. By using a spray, the volume of the essential oils can be controlled, and thus the amount imparted to the food or consumable liquid.

### CROSS-REFERENCE TO RELATED APPLICATIONS

The present application claims the benefit of U.S. Provisional Patent Application No. 62/597,490, filed Dec. 12, 2017, the disclosure of which is incorporated by reference herein in its entirety.

### FIELD OF THE INVENTION

The present application relates generally to compositions and methods for adding an aroma to foods and consumable liquids. The methods utilize spraying essential oil compositions that can provide an aroma, without significantly altering the taste of the food or liquid. By using a spray, the volume of the essential oils can be controlled, and thus the amount delivered to the food or consumable liquid.

### BACKGROUND OF THE INVENTION

While taste-imparting agents, such as bitters, have been commonly utilized in consumable liquids such as cocktails for some time, agents which impart an aroma, but without altering the taste of a consumable liquid, are less common. In addition, bitters contain alcohol and also add to the caloric content of a consumable liquid.

What is needed is an alternative that can provide an aroma to a consumable liquid without changing its taste, and in a controllable manner, that allows for very specific amounts of an agent.

### BRIEF SUMMARY OF THE INVENTION

The present invention fulfills these needs by providing compositions and methods of adding an aroma to food and consumable liquids, based on spraying essential oil compositions.

In embodiments, provided herein is a method of introducing an aroma to a consumable liquid, including spraying an essential oil composition onto the surface of the consumable liquid, the essential oil composition consisting essentially of an essential oil, and the essential oil composition being sprayed at a volume of about 0.005 mL to about 0.05 mL. In embodiments, the essential oil composition is sprayed at a volume of about 0.01 mL to about 0.04 mL.

Suitably, the spraying results in a droplet size (diameter) of about 100 μm to about 1,000 μm of the essential oil composition.

In embodiments, the spraying occurs between 1 to 3 times, each spray consisting of about 0.03 mL of the essential oil composition.

Exemplary essential oils that can be utilized include, but are not limited to, allspice berry essential oil, angelica seed essential oil, anise seed essential oil, basil essential oil, bay laurel essential oil, bay essential oil, bergamot essential oil, blood orange essential oil, camphor essential oil, caraway seed essential oil, cardamom seed essential oil, carrot seed essential oil, cassia essential oil, catnip essential oil, cedarwood essential oil, celery seed essential oil, German chamomile essential oil, Roman chamomile essential oil, cinnamon bark essential oil, cinnamon leaf essential oil, Citronella Essential Oil, Clary Sage Essential Oil, Clove Bud Essential Oil, Coriander Seed Essential Oil, Cypress Essential Oil, Elemi Essential Oil, Eucalyptus Essential Oil, Fennel Essential Oil, Fir Needle Essential Oil, Frankincense Essential Oil, Geranium Essential Oil, Ginger Essential Oil, Grapefruit Pink Essential Oil, Helichrysum Essential Oil, Hop Essential Oil, Hyssop Essential Oil, Juniper Berry Essential Oil, Labdanum Essential Oil, Lavender Essential Oil, Lemon Essential Oil, Lemongrass Essential Oil, Lime Essential Oil, Magnolia Essential Oil, Mandarin Essential Oil, Marjoram Essential Oil, Melissa Essential Oil, Mugwort Essential Oil, Myrrh Essential Oil, Myrtle Essential Oil, Neroli Essential Oil, Niaouli Essential Oil, Nutmeg Essential Oil, Orange Sweet Essential Oil, Oregano Essential Oil, Palmarosa Essential Oil, Patchouli Essential Oil, Pennyroyal Essential Oil, Pepper Black Essential Oil, Peppermint Essential Oil, Petitgrain Essential Oil, Pine Needle Essential Oil, Radiata Essential Oil, Ravensara Essential Oil, Rose Essential Oil, Rosemary Essential Oil, Rosewood Essential Oil, Sage Essential Oil, Sandalwood Essential Oil, Spearmint Essential Oil, Spikenard Essential Oil, Spruce Essential Oil, Star Anise Essential Oil, Sweet Annie Essential Oil, Tangerine Essential Oil, Tea Tree Essential Oil, Thyme Red Essential Oil, Verbena Essential Oil, Vetiver Essential Oil, Wintergreen Essential Oil, Wormwood Essential Oil, Yarrow Essential Oil, Ylang Ylang Extra Essential Oil, and Ylang Ylang III Essential Oil.

In embodiments, two or more of the essential oils can be utilized in the essential oil compositions.

In embodiments, the consumable liquid is an alcoholic consumable liquid, such as a spirit, a beer, a wine, or the consumable liquid can be a non-alcoholic consumable liquid.

### BRIEF DESCRIPTION OF DRAWINGS

The foregoing and other features and aspects of the present technology can be better understood from the following description of embodiments and as illustrated in the accompanying drawings. The accompanying drawings, which are incorporated herein and form a part of the specification, further serve to illustrate the principles of the present technology. The components in the drawings are not necessarily to scale.

FIG. 1 shows a method of introducing an aroma to a consumable liquid in accordance with embodiments hereof.

FIGS. 2A-2B show devices for introducing an aroma to a consumable liquid in accordance with embodiments hereof.

### DETAILED DESCRIPTION OF THE INVENTION

It should be appreciated that the particular implementations shown and described herein are examples and are not intended to otherwise limit the scope of the application in any way.

The published patents, patent applications, websites, company names, and scientific literature referred to herein are hereby incorporated by reference in their entirety to the same extent as if each was specifically and individually indicated to be incorporated by reference. Any conflict between any reference cited herein and the specific teachings of this specification shall be resolved in favor of the latter. Likewise, any conflict between an art-understood definition of a word or phrase and a definition of the word or phrase as specifically taught in this specification shall be resolved in favor of the latter.

As used in this specification, the singular forms “a,” “an” and “the” specifically also encompass the plural forms of the terms to which they refer, unless the content clearly dictates otherwise. The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 20%.

Technical and scientific terms used herein have the meaning commonly understood by one of skill in the art to which the present application pertains, unless otherwise defined. Reference is made herein to various methodologies and materials known to those of skill in the art.

In embodiments, provided herein are methods of introducing an aroma to a consumable liquid. As described herein, the methods can also be used to introduce an aroma to a solid-state, consumable food.

As used herein, the term “consumable liquid” refers to a liquid state, consumable food product, also generally known as a consumable beverage. Consumable liquids can include various alcoholic consumable liquids, such as spirits (e.g., whiskey, vodka, rum, gin, tequila, etc.), as well as beers and wines, wine coolers, malt beverages, etc. Consumable liquids also include non-alcoholic consumable liquids, such as water, coffee, tea, soft drinks (e.g., sodas), juices, etc.

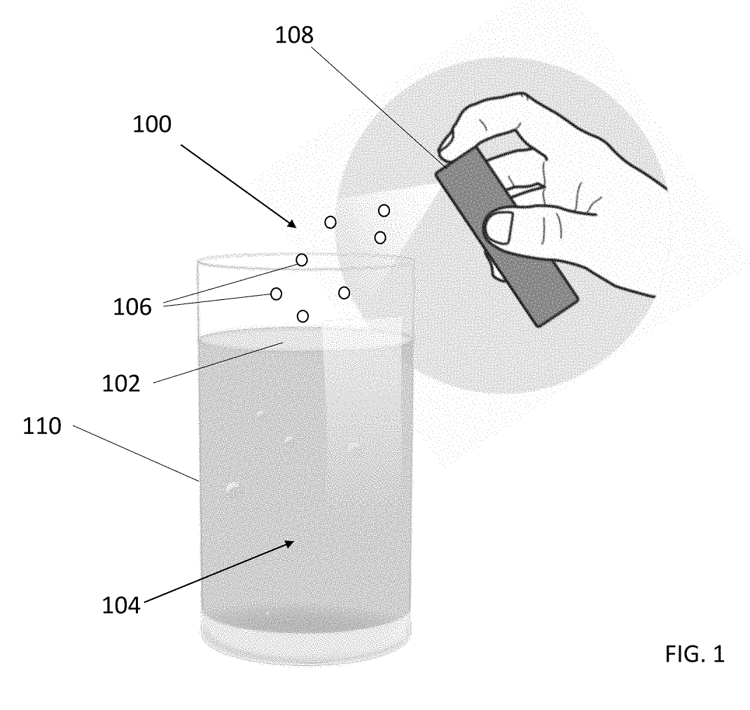

As illustrated in FIG. 1, in embodiments, the methods described herein introduce an aroma to a consumable liquid 104, suitably by spraying an essential oil composition 100 onto a surface 102 of consumable liquid 104, which is suitably held within a container 110 (e.g., glass, mug, bowl, etc.). The phrase “introduce(s) an aroma” to a consumable liquid (or food), means that the “aroma” i.e., the fragrance or scent, is modified, but that the taste of the consumable liquid (or food) is not significantly impacted. That is that the sensory stimulus from the tongue, provided by the consumable liquid, is not significantly changed, modified or impacted by the sprayed essential oil composition.

In embodiments, essential oil composition 100 consists essentially of an essential oil (one or more essential oils), but excludes solvents, such as alcohol, from the essential oil composition. That is, in embodiments in which the essential oil composition consists essentially of an essential oil, only one or more essential oils are included in the compositions.

As used herein an “essential oil” refers to a natural oil typically obtained by distillation or expression (e.g., cold pressing) and having the characteristic fragrance of the plant or other source from which it is extracted.

Exemplary essential oils that can be included in the essential oil composition include, but are not limited to, allspice berry essential oil, angelica seed essential oil, anise seed essential oil, basil essential oil, bay laurel essential oil, bay essential oil, bergamot essential oil, blood orange essential oil, camphor essential oil, caraway seed essential oil, cardamom seed essential oil, carrot seed essential oil, cassia essential oil, catnip essential oil, cedarwood essential oil, celery seed essential oil, chamomile German essential oil, chamomile Roman essential oil, vanilla essential oil, cacao (chocolate) essential oil, cinnamon bark essential oil, cinnamon leaf essential oil, Citronella Essential Oil, Clary Sage Essential Oil, Clove Bud Essential Oil, Coriander Seed Essential Oil, Cypress Essential Oil, Elemi Essential Oil, Eucalyptus Essential Oil, Fennel Essential Oil, Fir Needle Essential Oil, Frankincense Essential Oil, Geranium Essential Oil, Ginger Essential Oil, Grapefruit Pink Essential Oil, Helichrysum Essential Oil, Hop Essential Oil, Hyssop Essential Oil, Juniper Berry Essential Oil, Labdanum Essential Oil, Lavender Essential Oil, Lemon Essential Oil, Lemongrass Essential Oil, Lime Essential Oil, Magnolia Essential Oil, Mandarin Essential Oil, Marjoram Essential Oil, Melissa Essential Oil, Mugwort Essential Oil, Myrrh Essential Oil, Myrtle Essential Oil, Neroli Essential Oil, Niaouli Essential Oil, Nutmeg Essential Oil, Orange Sweet Essential Oil, Oregano Essential Oil, Palmarosa Essential Oil, Patchouli Essential Oil, Pennyroyal Essential Oil, Pepper Black Essential Oil, Peppermint Essential Oil, Petitgrain Essential Oil, Pine Needle Essential Oil, Radiata Essential Oil, Ravensara Essential Oil, Rose Essential Oil, Rosemary Essential Oil, Rosewood Essential Oil, Sage Essential Oil, Sandalwood Essential Oil, Spearmint Essential Oil, Spikenard Essential Oil, Spruce Essential Oil, Star Anise Essential Oil, Sweet Annie Essential Oil, Tangerine Essential Oil, Tea Tree Essential Oil, Thyme Red Essential Oil, Verbena Essential Oil, Vetiver Essential Oil, Wintergreen Essential Oil, Wormwood Essential Oil, Yarrow Essential Oil, Ylang Ylang Extra Essential Oil and Ylang Ylang III Essential Oil.

As described herein, in additional embodiments, the essential oil composition consists essentially of at least two of the essential oils, e.g., at least 2, at least 3, at least 4, at least 5, at least 6, etc., or consists essentially of 2, 3, 4, 5, 6, 7, etc., of the essential oils.

In embodiments in which the essential oil compositions comprise an essential oil, the essential oil compositions can include one or more essential oils as well as a solvent, but suitably do not include alcohol as the solvent.

In embodiments, essential oil composition 100 is sprayed at a volume of about 0.003 mL to about 0.08 mL. That is, the total liquid volume of essential oil composition 100 that exits a spray device 108 is about 0.003 mL to about 0.08 mL. More suitably, the volume of essential oil composition 100 that is sprayed is about 0.005 mL to about 0.05 mL, or about 0.008 to about 0.05 mL, or about 0.01 mL to about 0.04 mL, or about 0.015 mL to about 0.04 mL, or about 0.02 mL to about 0.04 mL, or about 0.02 mL to about 0.039 mL, or about 0.02 mL to about 0.038 mL, or about 0.02 mL to about 0.037 mL, or about 0.02 mL to about 0.036 mL, or about 0.02 mL to about 0.035 mL, or about 0.02 mL to about 0.034 mL, or about 0.02 mL to about 0.033 mL, or about 0.02 mL to about 0.032 mL, or about 0.02 mL to about 0.031 mL, or about 0.02 mL to about 0.030 mL, or about 0.021 mL to about 0.04 mL, or about 0.022 mL to about 0.04 mL, or about 0.023 mL to about 0.04 mL, or about 0.024 mL to about 0.04 mL, or about 0.025 mL to about 0.04 mL, or about 0.026 mL to about 0.04 mL, or about 0.027 mL to about 0.04 mL, or about 0.028 mL to about 0.04 mL, or about 0.029 mL to about 0.04 mL, or about 0.030 mL to about 0.04 mL, or about 0.031 mL to about 0.04 mL, or about 0.032 mL to about 0.04 mL, or about 0.033 mL to about 0.04 mL, or about 0.034 mL to about 0.04 mL, or about 0.035 mL to about 0.04 mL, or about 0.036 mL to about 0.04 mL, or about 0.037 mL to about 0.04 mL, or about 0.038 mL to about 0.04 mL, or about 0.039 mL to about 0.04 mL, or about 0.030 mL, or about 0.031 mL, or about 0.032 mL, or about 0.033 mL, or about 0.034 mL, or about 0.035 mL, or about 0.036 mL, or about 0.037 mL, or about 0.038 mL, or about 0.039 mL, or about 0.040 mL.

In embodiments, the spraying of the essential oil composition results in a droplet 106 size of about 100 μm to about 2,000 μm, in diameter, of the essential oil composition. As shown in FIG. 1, use of spray device 108 provides the unique delivery mechanism by spraying the essential oil composition, thereby providing a controlled amount (volume and weight) of the essential oil composition, as well as a droplet 106 size that is less than that provided via traditional dropper-based deliver devices. Each spray suitably includes about 2,000-10,000, or about 3,000-6,000, or about 5,000 droplets per spray. In additional embodiments, the droplet size is suitably about 100 μm to about 1,000 μm in diameter, or about 200 μm to about 1,000 μm, about 250 μm to about 1,000 μm, about 300 μm to about 1,000 μm, about 350 μm to about 1,000 μm, about 400 μm to about 1,000 μm, about 450 μm to about 1,000 μm, about 500 μm to about 1,000 μm, about 550 μm to about 1,000 μm, about 600 μm to about 1,000 μm, about 650 to about 1,000 μm, about 700 μm to about 1,000 μm, about 750 μm to about 1,000 μm, about 800 μm to about 1,000 μm, about 850 μm to about 1,000 μm, or about 900 μm to about 1,000 μm. Exemplary methods of measuring the droplet size of a spray are known in the art and include dynamic light-scattering, laser diffraction, gravitation measurements, etc.

In general, the specific gravity of the essential oils used in the essential oil composition will be in the range of about 0.5 to about 0.9 mg/mL. In embodiments, this translates to a mass of essential oil delivered by the spraying of about 0.01 g/spray to about 0.04 g/spray. Calculation of the mass of essential oil delivered by each spray is well within the level of ordinary skill in the art.

In embodiments of the methods described herein, the spraying of essential oil composition 100 suitably occurs between 1 to 10 times for each consumable liquid. That is, each serving of a consumable liquid (each glass, mug, bowl, etc., of a consumable liquid) receives 1 to 10 sprays of the essential oil composition to provide the aroma desired. In embodiments, the spraying can occur between 1 to 9 times, 1 to 8 times, 1 to 7 times, 1 to 6 times, 1 to 5 times, 1 to 4 times, 1 to 3 times, 1 to 2 times, or 1 time, 2 times, 3 times, 4 times, 5 times, 6 times, 7 times, 8 times, 9 times or 10 times.

In suitable embodiments, each of the 1 to 10 sprays consists of about 0.02 mL to about 0.04 mL, and more suitably about 0.03 mL, of the essential oil composition, including about 0.030 mL, about 0.031 mL, about 0.032 mL, about 0.033 mL, about 0.034 mL, about 0.035 mL, about 0.036 mL, about 0.037 mL, about 0.038 mL, about 0.039 mL or about 0.040 mL.

As described herein, it is the spraying of the essential oil composition that allows for a precise delivery of the essential oil composition at a desired volume (e.g., about 0.02-0.04 mL/spray) and with a desired droplet size (e.g., about 250 μm to about 1000 μm) that provides to the introduction of the aroma to the consumable beverage.

In further embodiments, provided herein is a method of introducing an aroma to a consumable liquid, which includes spraying essential oil composition 100 onto surface 102 of consumable liquid 104. As described herein, the essential oil composition consists essentially of an essential oil (or multiple essential oils), and the essential oil composition is sprayed at a volume of about 0.01 mL to about 0.05 mL. The spraying suitably results in droplet 106 size of about 250 μm to about 1,000 μm of the essential oil composition. As discussed herein, embodiments, the essential oil composition is sprayed at a volume of about 0.02 mL to about 0.04 mL, and in suitable embodiments, the spraying occurs between 1 to 3 times, with each of the sprays consisting of about 0.03 mL of the essential oil composition.

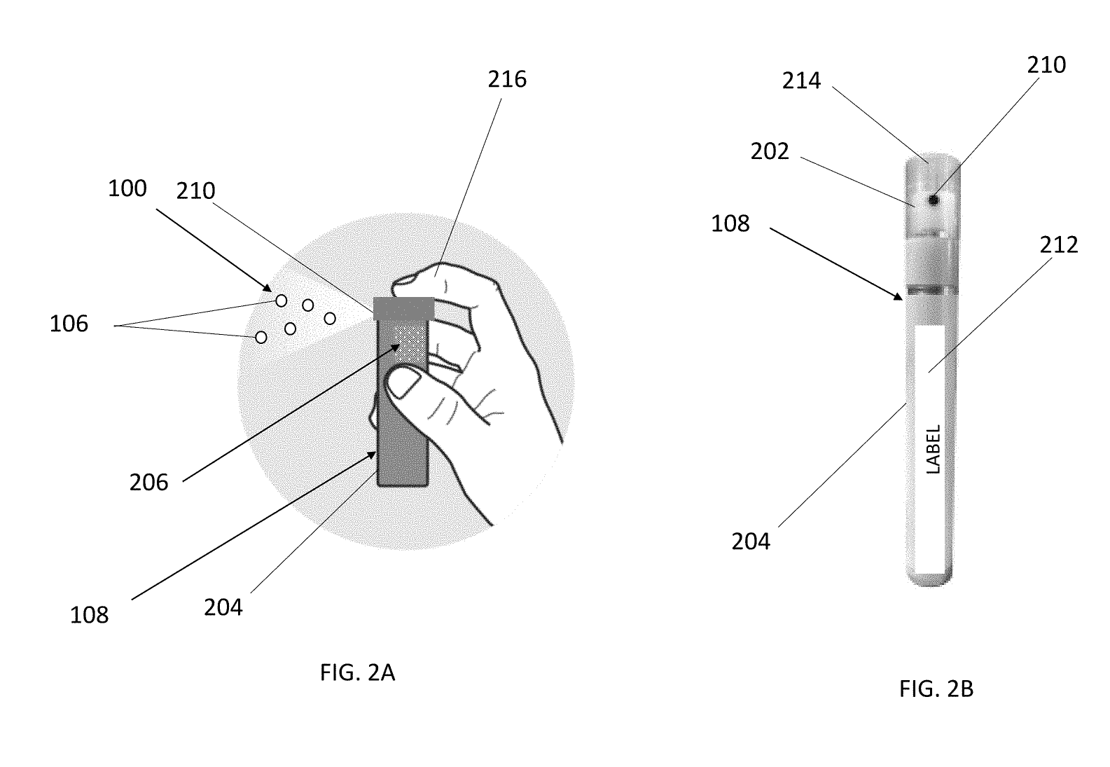

FIGS. 2A and 2B show an exemplary spray device 108 that can be used to spray and deliver the essential oil compositions to a consumable liquid (or a consumable food). As shown in FIGS. 2A and 2B, spray device 108 suitably includes a container 204 for holding a stored essential oil composition 206 prior to being sprayed as essential oil composition 100. Spray device 108 also suitably includes a spray nozzle 210, a pump 202 (suitably connected internally to tubing or other structure (not shown) to draw-up stored essential oil composition 206), as well as a cap 214 for covering and protecting the spray nozzle and the pump, and a label 212 for indicating the type(s) of essential oil of the essential oil composition contained within the container. Pump 202 is suitably compressed via a user's finger 216 to activate the pump, thereby drawing stored essential oil composition 206 up to spray nozzle 210, and then dispersing or spraying essential oil composition 100 onto surface 102 of consumable liquid 104.

Container 204 can be constructed of any suitable material, including metals, plastics, glass, etc., that can maintain stored essential oil composition 206 for an extended period (e.g., 3-6 months or 6-12 months, 12-18 months, or longer, i.e., 1-3 years) without degradation of the stored essential oil composition or loss of the ability to provide an aroma upon spraying. In embodiments, container 204 suitably is a metal tube or can with a lining that does not interact with stored essential oil composition 206, for example an aluminum tube or can lined with Bisphenol A non-intent (BPA-NI, or with no BPA intentionally added) powder liner or coating (e.g., a HOBA™ PURAIR™ coating; PPG Industries, Pittsburgh, Pa.).

In general, the volume of spray device 108 will be on the order of about 10 mL to 20 mL, containing approximately 200 to 1,000, sprays per device.

The methods provided herein can be used to provide replacements for fresh fruits and vegetables, providing a desired aroma to a consumable beverage, without requiring the cost and potential difficulty of acquiring the produce (e.g., out of season, cruise ship, airplane flight, outer space, remote location). The essential oils utilized in the methods and compositions described herein are approved by the Food and Drug Administration and adhere to United States Pharmacopeia standards, and also allow for greater freedom of selection and the standardization for specific blends of essential oils (i.e., a combination of 2 or more essential oils to generate a unique aroma profile).

The methods can also be used to provide an aroma for consumable liquids and solids that may not generally have a discernable fragrance, for example frozen drinks such as daiquiris and margaritas, ice cream cakes, other frozen edibles, etc., due to their cold temperature and lack of a volatile fragrance or aroma.

As described herein, the methods provided can also be used to introduce an aroma to a consumable food, for example a solid-state consumable food, such as a dessert (pie, cake, ice cream, etc.), meat (e.g., chicken, fish, beef, pork, etc.), grain product (e.g., bread, pasta, etc.), fruit, vegetable, etc.

It is to be understood that while certain embodiments have been illustrated and described herein, the claims are not to be limited to the specific forms or arrangement of parts described and shown. In the specification, there have been disclosed illustrative embodiments and, although specific terms are employed, they are used in a generic and descriptive sense only and not for purposes of limitation. Modifications and variations of the embodiments are possible in light of the above teachings. It is therefore to be understood that the embodiments may be practiced otherwise than as specifically described.

While various embodiments have been described above, it should be understood that they have been presented only as illustrations and examples of the present technology, and not by way of limitation. It will be apparent to persons skilled in the relevant art that various changes in form and detail can be made therein without departing from the spirit and scope of the present technology. Thus, the breadth and scope of the present technology should not be limited by any of the above-described embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A method of introducing an aroma to a consumable liquid, comprising:
spraying an essential oil composition onto the surface of the consumable liquid,
the essential oil composition consisting essentially of an essential oil, and
the essential oil composition being sprayed at a volume of about 0.005 mL to about 0.05 mL.

2. The method of claim 1, wherein the essential oil composition is sprayed at a volume of about 0.01 mL to about 0.04 mL.

3. The method of claim 1, wherein the spraying results in a droplet size of about 100 μm to about 1,000 μm of the essential oil composition.

4. The method of claim 1, wherein the spraying occurs between 1 to 3 times, each spray consisting of about 0.03 mL of the essential oil composition.

5. The method of claim 1, wherein the essential oil composition consists essentially of at least one essential oil selected from the group consisting of allspice berry essential oil, angelica seed essential oil, anise seed essential oil, basil essential oil, bay laurel essential oil, bay essential oil, bergamot essential oil, blood orange essential oil, camphor essential oil, caraway seed essential oil, cardamom seed essential oil, carrot seed essential oil, cassia essential oil, catnip essential oil, cedarwood essential oil, celery seed essential oil, German chamomile essential oil, Roman chamomile essential oil, cinnamon bark essential oil, cinnamon leaf essential oil, Citronella Essential Oil, Clary Sage Essential Oil, Clove Bud Essential Oil, Coriander Seed Essential Oil, Cypress Essential Oil, Elemi Essential Oil, Eucalyptus Essential Oil, Fennel Essential Oil, Fir Needle Essential Oil, Frankincense Essential Oil, Geranium Essential Oil, Ginger Essential Oil, Grapefruit Pink Essential Oil, Helichrysum Essential Oil, Hop Essential Oil, Hyssop Essential Oil, Juniper Berry Essential Oil, Labdanum Essential Oil, Lavender Essential Oil, Lemon Essential Oil, Lemongrass Essential Oil, Lime Essential Oil, Magnolia Essential Oil, Mandarin Essential Oil, Marjoram Essential Oil, Melissa Essential Oil, Mugwort Essential Oil, Myrrh Essential Oil, Myrtle Essential Oil, Neroli Essential Oil, Niaouli Essential Oil, Nutmeg Essential Oil, Orange Sweet Essential Oil, Oregano Essential Oil, Palmarosa Essential Oil, Patchouli Essential Oil, Pennyroyal Essential Oil, Pepper Black Essential Oil, Peppermint Essential Oil, Petitgrain Essential Oil, Pine Needle Essential Oil, Radiata Essential Oil, Ravensara Essential Oil, Rose Essential Oil, Rosemary Essential Oil, Rosewood Essential Oil, Sage Essential Oil, Sandalwood Essential Oil, Spearmint Essential Oil, Spikenard Essential Oil, Spruce Essential Oil, Star Anise Essential Oil, Sweet Annie Essential Oil, Tangerine Essential Oil, Tea Tree Essential Oil, Thyme Red Essential Oil, Verbena Essential Oil, Vetiver Essential Oil, Wintergreen Essential Oil, Wormwood Essential Oil, Yarrow Essential Oil, Ylang Ylang Extra Essential Oil, and Ylang Ylang III Essential Oil.

6. The method of claim 5, wherein the essential oil composition consists essentially of at least two of the essential oils.

7. The method of claim 1, wherein the consumable liquid is an alcoholic consumable liquid.

8. The method of claim 7, wherein the alcoholic consumable liquid comprises a spirit.

9. The method of claim 7, wherein the alcoholic consumable liquid comprises a beer.

10. The method of claim 7, wherein the alcoholic consumable liquid comprises a wine.

11. The method of claim 1, wherein the consumable liquid is a non-alcoholic consumable liquid.

12. A method of introducing an aroma to a consumable liquid, comprising:
spraying an essential oil composition onto the surface of the consumable liquid,
the essential oil composition consisting essentially of an essential oil, and
the essential oil composition being sprayed at a volume of about 0.01 mL to about 0.05 mL,
wherein the spraying results in a droplet size of about 250 μm to about 1,000 μm of the essential oil composition.

13. The method of claim 12, wherein the essential oil composition is sprayed at a volume of about 0.02 mL to about 0.04 mL.

14. The method of claim 12, wherein the spraying occurs between 1 to 3 times, each spray consisting of about 0.03 mL of the essential oil composition.

15. The method of claim 12, wherein the essential oil composition consists essentially of at least one essential oils selected from the group consisting of allspice berry essential oil, angelica seed essential oil, anise seed essential oil, basil essential oil, bay laurel essential oil, bay essential oil, bergamot essential oil, blood orange essential oil, camphor essential oil, caraway seed essential oil, cardamom seed essential oil, carrot seed essential oil, cassia essential oil, catnip essential oil, cedarwood essential oil, celery seed essential oil, chamomile German essential oil, chamomile Roman essential oil, cinnamon bark essential oil, cinnamon leaf essential oil, Citronella Essential Oil, Clary Sage Essential Oil, Clove Bud Essential Oil, Coriander Seed Essential Oil, Cypress Essential Oil, Elemi Essential Oil, Eucalyptus Essential Oil, Fennel Essential Oil, Fir Needle Essential Oil, Frankincense Essential Oil, Geranium Essential Oil, Ginger Essential Oil, Grapefruit Pink Essential Oil, Helichrysum Essential Oil, Hop Essential Oil, Hyssop Essential Oil, Juniper Berry Essential Oil, Labdanum Essential Oil, Lavender Essential Oil, Lemon Essential Oil, Lemongrass Essential Oil, Lime Essential Oil, Magnolia Essential Oil, Mandarin Essential Oil, Marjoram Essential Oil, Melissa Essential Oil, Mugwort Essential Oil, Myrrh Essential Oil, Myrtle Essential Oil, Neroli Essential Oil, Niaouli Essential Oil, Nutmeg Essential Oil, Orange Sweet Essential Oil, Oregano Essential Oil, Palmarosa Essential Oil, Patchouli Essential Oil, Pennyroyal Essential Oil, Pepper Black Essential Oil, Peppermint Essential Oil, Petitgrain Essential Oil, Pine Needle Essential Oil, Radiata Essential Oil, Ravensara Essential Oil, Rose Essential Oil, Rosemary Essential Oil, Rosewood Essential Oil, Sage Essential Oil, Sandalwood Essential Oil, Spearmint Essential Oil, Spikenard Essential Oil, Spruce Essential Oil, Star Anise Essential Oil, Sweet Annie Essential Oil, Tangerine Essential Oil, Tea Tree Essential Oil, Thyme Red Essential Oil, Verbena Essential Oil, Vetiver Essential Oil, Wintergreen Essential Oil, Wormwood Essential Oil, Yarrow Essential Oil, Ylang Ylang Extra Essential Oil, and Ylang Ylang III Essential Oil.

16. The method of claim 15, wherein the essential oil composition consists essentially of at least two of the essential oils.

17. The method of claim 12, wherein the consumable liquid is an alcoholic consumable liquid.

18. The method of claim 17, wherein the alcoholic consumable liquid comprises a spirit.

19. The method of claim 17, wherein the alcoholic consumable liquid comprises a beer.

20. The method of claim 17, wherein the alcoholic consumable liquid comprises a wine.

21. The method of claim 12, wherein the consumable liquid is a non-alcoholic consumable liquid.
